(19) United States
(12) Patent Application Publication
(10) Pub. No.: US 2005/0071294 A1
(43) Pub. Date: Mar. 31, 2005

(54) Mailing machine scanner apparatus and method

(76) Inventors: Jeffrey P. Rios, Easton, CT (US); Joseph D. Collins, Watertown, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 10/673,085

(22) Filed: Sep. 26, 2003

(51) Int. Cl. G06F 17/00; G07B 17/02

(52) U.S. Cl. 705/404; 705/401

(57) ABSTRACT

A method and apparatus for processing a mailpiece. The method includes receiving a mailpiece that has a barcode printed on the mailpiece. The barcode being in machine-readable format. Next, image data of the mailpiece is obtained. Postage data is calculated as a function of the data of the barcode and an indicia is printed on the mailpiece that represents the postage data. A control signal is generated as a function of the representative data and operation of a mailing machine is modified as a function of the control signal. Furthermore, the barcode can contain data that is transmitted to a server and used for tracing the location of the mailpiece and confirming delivery of the mailpiece.

### 1. TECHNICAL FIELD

The present invention relates to a mailing machine that has a scanning device to read a barcode that is on the mailpiece. More particularly, the present invention relates to scanning mailpieces and using the barcode data to process the mail.

### 2. BACKGROUND

Conventional methods used to generate mailpieces and mailings typically require multiple steps, which are performed asynchronously and on different pieces of equipment. For example, one may use an address management software package, such as SMARTMAILER™ (SMARTMAILER is a trademark of Pitney Bowes Inc., Stamford Conn.) to generate the output data that complies with postal requirements; ENVELOPE DESIGNER™ (ENVELOPE DESIGNER is a trademark of Pitney Bowes Inc., Stamford, Conn.) may be used to print address data on the mailpieces; and a mailing machine, such as a PARAGON® (PARAGON is a registered trademark of Pitney Bowes Inc., Stamford Conn.) may be used to frank the mailpieces.

While the use of these processes and products enables a user to process and organize mail operations and mailing tasks, the user must be careful to keep the mailpieces organized. Throughout this process the physical integrity and/or sequence of the mailing, i.e., packages, parcels, and trays of mail, must be maintained to prevent loss and to ensure that the proper postage charges are paid and any available reductions based on volume, presorting or other additional manipulation performed prior to depositing the mailpieces with the United States Postal Service (USPS) (workshare) are tracked. Furthermore, the mailing must be uniform (i.e., every piece has the same postage) or the mailing machine must be manually set to generate the correct amount of postage for each piece if the mailing contains pieces with different amounts of postage.

As stated previously, while the above-described products and processes enable mailpiece manipulation, it would be an advancement in the state of the art to have a more efficient process that utilizes additional features and capabilities.

### SUMMARY OF THE INVENTION

In order to advance the state of the art, the present invention relates to a method and apparatus that enables mailpieces of a mailing to be efficiently processed and tracked using data stored in a barcode that is printed on the mailpiece and scanned to obtain and use the encoded data.

Accordingly, one embodiment of the present invention is directed to a method for processing a mailpiece that includes receiving a mailpiece that has representative data on a region of the mailpiece; the representative data being in machine-readable format. Next, image data of the mailpiece is obtained. Postage data is calculated as a function of the representative data and an indicia is printed on the mailpiece that represents the postage data. A control signal is generated as a function of the representative data and operation of a mailing machine is modified as a function of the control signal.

Another embodiment of the present invention is directed to the method described above and wherein the representative data is in a predetermined format, such as a barcode (e.g., 2-d barcode), or an encrypted format.

Yet another embodiment of the present invention is directed to the method described above and wherein the control signal controls the mailing machine to temporarily pause operation of the mailing machine.

Yet another embodiment of the present invention is directed to the method as described above and further including using the representative data for tracing purposes and/or delivery confirmation purposes.

Yet another embodiment of the present invention is directed to an apparatus that includes means for receiving a mailpiece that has representative data on a region of the mailpiece, the representative data being in machine-readable format. The apparatus also includes means for obtaining image data of the mailpiece and means for calculating postage data as a function of the representative data. Furthermore the apparatus includes means for printing an indicia on the mailpiece that represents the postage data and means for generating a control signal as a function of the representative data. Additionally, the apparatus has means for modifying operation of a mailing machine as a function of the control signal.

Yet another embodiment of the present invention is directed to means for transmitting at least a portion of the image data to a storage location. Once at the storage location, a server for example, the data can be used for tracing the mailpiece.

Yet another embodiment of the present invention is directed to an apparatus that includes an input module adapted to receive a mailpiece. An imaging module obtains image data from the mailpiece. A mailing machine calculates postage as a function of the image data and prints an indicia on the mailpiece. Furthermore, the image data is used to generate a control signal, which modifies operation of the apparatus.

### BRIEF DESCRIPTION OF THE DRAWINGS

FIG. 1 shows a diagram of one embodiment of the present invention.

FIG. 2 shows a flowchart of steps to implement the present invention.

### DETAILED DESCRIPTION OF THE INVENTION

The present invention advances the state of the art by providing an improved method and apparatus to process mailpieces that are part of a batch of mailpieces. Mailpieces, as used herein, is defined to comprise letters, envelopes, windowed envelopes, self-mailers, business reply envelopes, postcards, parcels, packages, express mail packages, bulk mail, catalogs, flyers, magazines and any material that an indicia may be printed on or a label having an indicia may adhered to.

An optical scanner is integrated with a mailing machine and representative data, such as barcodes, are printed on the mailpieces as they are created, for example, by Mail Creations equipment, such as SMARTMAILER™/ENVELOPE DESIGNER™ and the ADDRESSRIGHT™ equipment. (SMARTMAILER, ENVELOPE DESIGNER and ADRESSRIGHT are trademarks of Pitney Bowes Inc., Stamford, Conn.)

Alternatively, a representation of data may be applied manually by a user, for example, using a stamp or roller device or label. Thus, while the use of mail creations equipment, as described above, is not necessary, it is a preferred embodiment to use such equipment for efficiency, quality and speed considerations. Yet another alternative is that the representation of data is printed on one or more documents. A selected portion of the document may be accessed by a scanner to obtain the data. For example, the data can be printed on an area of the document that is visible through a window of the envelope.

The representation, such as a barcode, is capable of containing multiple types of information. The information may include, for example, postage rate information, postage charge information, reduced postage information, class of delivery information, surcharge information, package break data and tray break data, destination address data, sender address data, special delivery information, delivery confirmation data, sequence data and any other type of data that may be represented in a coded or condensed format. This includes coding/condensing other data that may already be represented as another barcode on the mailpiece. This is accomplished by determining information contained in other bar codes and encoding that information into the representation described herein. Thus, a single coded representation may include a variety of information about the mailpiece. Therefore, decoding the single representation may provide all recorded information about the mailpiece.

As the mailpieces are fed into the mailing machine, the scanner captures an image of the mailpiece, or merely reads or interprets the barcoded information, which may then be transmitted to a server, for example a MailCode PostBackOffice® (PostBackOffice is a trademark of Pitney Bowes Inc., Stamford, Conn.) server, for tracking and tracing purposes. The scanner could also interpret the barcode on the mailpiece and signal the mailing machine to set the indicated postage amount. The scanner could also detect a tray and/or package break indicator, and pause the mailing machine's feeder, thus allowing an operator to remove mailpieces from the output tray and package/tray the mailpieces without disturbing the sequence of the mailpieces.

The following steps may be used to implement the present invention. During the presorting processing, the mail list is populated with postage and package/tray information. During the printing of the mailpieces, for example, using ADDRESSRIGHT™ (ADDRESSRIGHT is a trademark of Pitney Bowes Inc., Stamford, Conn.) and ENVELOPE DESIGNER™ (ENVELOPE DESIGNER is a trademark of Pitney Bowes Inc., Stamford, Conn.) products, a barcode is printed on the mailpiece. (As used herein, the bar code is used to denote one example of representative data. The barcode may be any coded representation of information expressed as a 2-d barcode, encrypted barcode, or other suitable representation of data.)

The barcode could be added to every mailpiece, or only added to the first mailpiece of a set (a set being plural mailpieces with the same information). The barcode indicates the required (including any discounts) postage amount as calculated, for example by SmartMailer™. (SMARTMAILER is a trademark of Pitney Bowes Inc., Stamford, Conn.) It also indicates the package and tray breaks. The barcode may be in addition to any PLANET™ (PLANET is a trademark of the United States Postal Service) and/or POSTNET barcode or any other information, whether coded, typed or written, that may be on the mailpiece. The scanner may read information from the existing barcodes in addition to the barcode described herein. Also, the scanner may read only the barcode described herein, which may or may not include data from other barcodes on the mailpiece.

As the mailpieces are fed into the mailing machine, an image obtaining device, such as an optical scanner, captures an image of the mailpiece, which may be transmitted to a remote location, such as a server, for example, MailCode PostBackOffice™ server. The image data may be utilized to build a data file that the server uses to support its tracking logic (i.e., apriori knowledge of the mail list) for track and trace purposes. Furthermore, it enables the user to see actual images of the mailpiece, which builds user confidence.

As the mailpiece is fed into the mailing machine, the scanner reads the barcode on the mailpiece and sets the indicated postage amount.

Thus, to summarize briefly, the present invention provides an advancement in the state of the art by enabling a remote server to obtain necessary information about the mailing, for example, image data, names and/or addresses (either sender addresses and/or recipient addresses). The present invention also reduces the amount of effort for mail preparation since the packaging and traying functions may occur after the mailpieces have been franked. Furthermore, the present invention automates the postage setting of the mailing machine for mailings that contain various postage amounts.

Another advantage of the present invention is that the input feeding operation can be paused, or temporarily stopped, to permit an operator of the mailing machine to package the mailpieces or place the mailpieces into an appropriate tray, or other containing apparatus, thereby maintaining the integrity of the mailing by maintaining the sequence of mailpieces in the mailing. This capability reduces the likelihood of errors in the mailing and reduces the need for an operator to separate the mailpieces as they are being fed into the mailing machine.

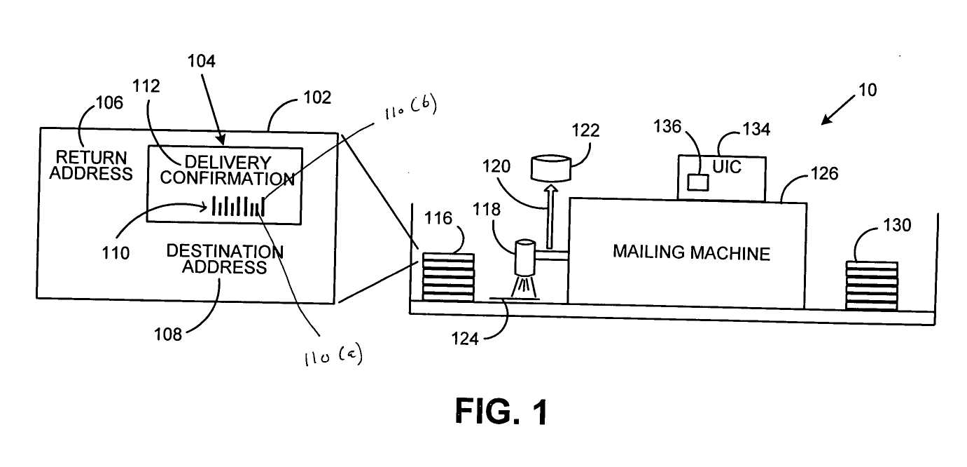

FIG. 1 shows a system 10 that comprises a mailpiece 102, a feeder 116, an optical device 118, a franking device 126, a server 122 and an output module 130.

Mailpiece 102 is any document or plurality of documents that may be transported through the United States Postal Service (USPS) or other carrier that is processed and traced during delivery stages. FIG. 1 shows mailpiece 102 as an envelope, which may enclose documents such as a letter or other items. Mailpiece 102 has a plurality of regions on the surface thereof. Region 106 may be used for return address data, region 108 may be used to print recipient address data and region 104 may be used to print a machine-readable representation 110 and delivery data 112.

While FIG. 1 shows the machine-readable representation 110 as a barcode, it is to be understood that any encoded representation of data could be printed as machine-readable representation 110. This includes, for example, encoded data, barcode data and encrypted data. The coded representation can be decoded and the data therein may be used for processing and/or delivery tracing purposes. For example, a portion of the coded representation 110(a) may be used to identify the location of a mailpiece in a sequence of mailpieces. Furthermore, a second portion 110(b) may be used to indicate what type of delivery confirmation is required for the mailpiece. The representation 110 could also include information that is present on other regions of the mailpiece, such as information coded in other barcodes such as a PLANET™ (PLANET is a trademark of the United States Postal Service) and/or POSTNET barcode, or typed or written data. Thus, to obtain information about the mailpiece, only decoding the representation 110 would be necessary.

Input feeder device 116 is used to receive a plurality of mailpieces 102. Input feeder may be, for example, an input stacker, or other feeder device. The feeder 116 feeds the mailpieces to scanning device 118.

Scanning device 118 is typically an optical scanner with OCR (optical character recognition) capability, OMR (optical mark recognition) capability or other imaging device. Platform 124, may be used to transport mailpiece 102 along a path such that the mailpiece can be scanned by scanner 118. Alternatively, platform 124 may also perform a weighing function such as a “weigh-on-the-way”, whereby the mass of each mailpiece is obtained and provided to mailing machine 126. This mass quantity may be used to calculate postage by the mailing machine 126.

The scanner device, or image obtaining unit, 118 is operatively coupled to mailing machine 126, such that data obtained from the scanner 118, and platform 124 can be provided to the mailing machine 126. The mailing machine 126 has UIC 134, which may include a processing chip 136, which may be an ASIC or other controller. Alternatively, the mailing machine 126 may have processors and controllers (not shown) within the machine 126 that are capable of performing data processing and control functions. The mailing machine is adapted to calculate postage data and print the postage on the mailpiece 102.

Image obtaining facility (also referred to as a scanner, scanning device and image obtaining unit herein) 118 is also operatively coupled to a storage location 122 by a coupling medium 120. This coupling medium 120 may be a bi-directional communications link, a network connection, wired connection, wireless connection, LAN (local area network) WAN (wide area network), Internet, or other data transmission means. Data can be transmitted from the image obtaining facility 118 and stored at storage location 122. Storage location 122 is typically a server, or memory location such as RAM (random access memory), ROM (read only memory), EEPROM (electronic erasable programmable read only memory), PROM (programmable read only memory), NVM (non-volatile memory) or other suitable memory device. The server 122 also has processing capabilities such that the data can be processed, accessed and/or transmitted from server 122.

The scanner is capable of reading the barcode, uploading the barcode data to server 122 or transmit the barcode data to an alternate location, such as a USPS server. Based on the data in the barcode, the postage amount may be modified. For example, if delivery confirmation, special delivery, hazardous material, insurance, or other action is required to be taken on the mailpiece, a surcharge may be added to the postage amount. This surcharge data can be transmitted to the mailing machine so that the adjusted postage amount can be calculated.

The data that is transmitted from scanner 118 is typically image data that is obtained from mailpiece 102. The data is stored at the server 122, and the server 122 may further transmit the image data to another location, or permit retrieval of the image data. This processing and accessing capability enables the image data to be used to trace the location of a mailpiece or a plurality of mailpieces. This image data also enables confirmation of delivery of a mailpiece to a particular destination, such as a recipient's destination. When the data is retrieved, an image of the mailpiece may be transmitted from storage location 122 to a remote location. Thus, tracing the mailpiece yields retrieval of an image of the mailpiece. This enhances user confidence since the user can clearly view the handwriting, dimensions and format of the mailpiece.

The server 122 may also process the image data by utilizing the encoded data. The processing includes, for example, organizing the data, sorting the data and transmitting the data.

Mailing machine 126 is also operatively coupled to an output module, or output facility 130. As shown in FIG. 1, output facility 130 is an output tray. The output module 130 may be a transport mechanism, output stacker, belt, bin, tray, or other container that is adapted to receiving processed mail.

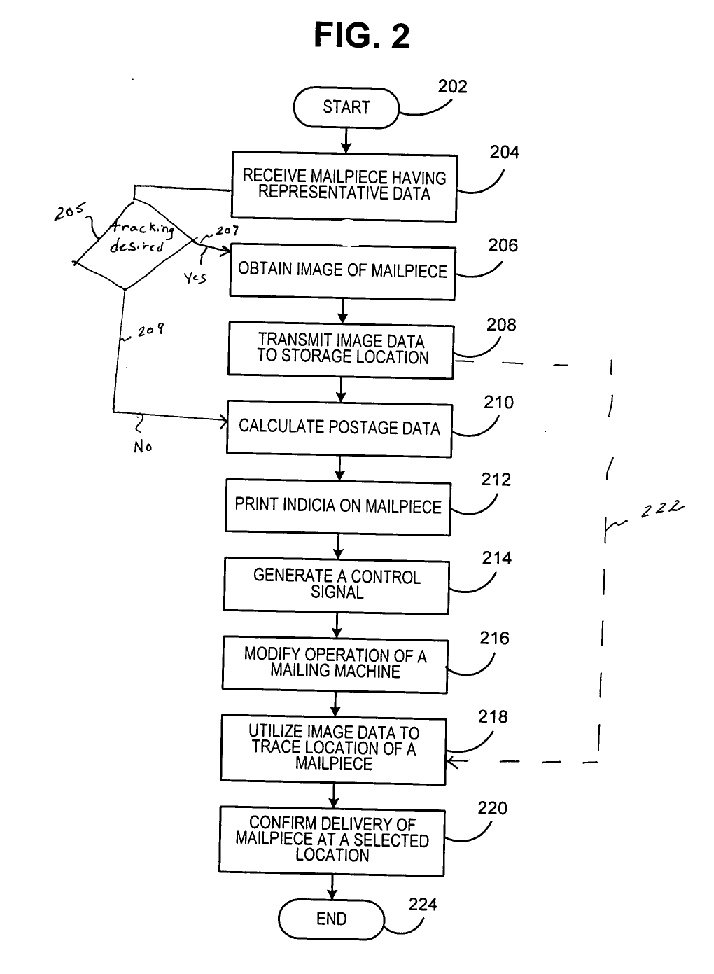

FIG. 2 shows a flowchart 20 of steps that may be used to implement the present invention. These steps may include processes performed by apparatus and steps stored on a computer-readable medium, which includes program code to perform the desired functions.

As shown in FIG. 2, start block 202 initiates the process. Block 204 shows that a mailpiece is received at an input location, such as an input stacker of a mail processing machine. Block 205 determines whether tracking of the mailpiece is desired. If “YES” line 207 leads to block 206. If tracking is not desired, “NO” line 209 leads to block 210.

Block 206 shows that image data of the mailpiece is obtained. This may be accomplished, for example, by a scanner device or optical mark recognition device, optical character recognition device, or other suitable device that is capable of capturing an image of each, or selected, mailpieces.

Block 208 shows that some, or all, of the image data may be transmitted to a storage location. This storage location is, for example, electronic storage, a server, a RAM, ROM, PROM, NVM, EEPROM or other medium that is capable of storing the image data. The storage location may be in proximity to the mailpiece or may be remote, and accessed through a network such as a LAN, WAN, Internet or DSL (dedicated subscriber line). Dashed line 222 leads to block 218 if postage is not to be calculated and tracking is desired.

Block 210 shows that postage data is calculated. This calculation is typically a function of the representation data, a portion of which may include the amount of postage, or fees, required by the USPS, or other carrier.

Block 212 shows that an indicia is printed on the mailpiece. This step may include printing the indicia directly on a portion of the mailpiece, or alternatively, printing the indicia on a label and affixing the label to the mailpiece.

Block 214 shows that a control signal is generated. This control signal may be generated by the mailing machine, or in a user-interface-controller. Block 216 shows that the control signal is used to modify operation of the mailing machine. This modified operation may be, for example, temporary stoppage, or pausing the machine.

Block 218 shows that the image data can be used to trace the location of a mailpiece and block 220 shows delivery confirmation of the mailpiece at a particular location.

Block 224 is an end block.

The present invention has been described in terms of a method, which may be stored on a computer-readable medium. The method may comprise a series of program code steps to perform the above-described functions. The present invention is also directed to an apparatus, which includes structural elements. These structural elements can be defined as, for example, means for receiving a mailpiece. The means for receiving the mailpiece include, for example, an input stacker, an input feeder on a mail sortation or franking machine or other module or facility that receives mailpieces and transports, sorts or organizes the mailpieces.

The apparatus of the present invention may also include means for obtaining image data of the mailpiece. These means include, for example, a scanner, a barcode reader, an OCR device, an OMR device, an imaging device, or other apparatus capable of obtaining information from a barcode, or other coded or encrypted representation of data.

The apparatus of the present invention may also include means for calculating postage data. This may include, for example, a postage vault stored in NVM, a franking device, or a processor that obtains data from the bar code, or other source that provides postage data about a mailpiece and uses that data to generate a postage amount.

The apparatus of the present invention may also include means for printing an indicia on the mailpiece. This may include, for example, a printer operatively coupled to the calculating means described above, or a print assembly that is part of the mailing machine, or other printing apparatus capable of printing on an indicia on a mailpiece.

The apparatus of the present invention may also include means for generating a control signal. This may include, for example, an IC (integrated circuit) an ASIC (application specific integrated circuit), or other control module, control facility or processor that is adapted to generate and transmit control signals.

The apparatus of the present invention may also include means for modifying operation of a mailing machine as a function of the control signal. This may include utilizing the control signal to slow down, or reduce, the operational rate of the machine, temporarily stop operation of the machine, pause operation of the machine or change the mode of operation, such as enabling or disabling selected features of the machine.

An alternate embodiment of the present invention involves a user printing a coded representation, such as a barcode or ASCII (alphanumeric) information on a mailpiece. The scanning device, or image obtaining device, has OCR capability and a user sends (electronically or on a floppy disk) the postage data, tray break data, confirmation delivery data to the UIC or processor of a mailing machine. For example, the data could be provided in a table or matrix that correlates an identifier, which identifies the mailpiece, a postage amount, a tray break indicator and the UIC compares the identifier read by the scanning device with the stored identifier to determine a match.

While the above description provides various examples and embodiments of the present invention, it is possible to modify the invention without departing from the spirit and scope of the invention as set forth in the claims that follow.

1. A method for processing a mailpiece comprising:
receiving a mailpiece that includes representative data on a region of the mailpiece, the representative data being in machine-readable format;
obtaining image data of the mailpiece;
transmitting at least a portion of the image data to a storage location for subsequent use in tracking the mailpiece;
calculating postage data as a function of the representative data;
printing an indicia on the mailpiece that represents the postage data;
generating a control signal as a function of the representative data; and
modifying operation of a mailing machine as a function of the control signal.

2. The method as claimed in claim 1, wherein modifying operation of a mailing machine includes temporarily pausing operation of the mailing machine.

3. The method as claimed in claim 1, wherein the representative data includes a barcode.

4. The method as claimed in claim 1, wherein the representative data is encoded.

5. The method as claimed in claim 1, wherein the representative data is encrypted.

6. The method as claimed in claim 1, wherein the representative data uniquely identifies the mailpiece.

7. Cancelled.

8. The method as claimed in claim 1, wherein calculating postage data further comprises:
adding a surcharge to a postage amount for the mailpiece to account for additional services specified for the mailpiece in the representative data.

9-12. Cancelled.

13. An apparatus comprising:
means for receiving a mailpiece that has representative data on a region of the mailpiece, the representative data being in machine-readable format;
means for obtaining image data of the mailpiece;
means for transmitting at least a portion of the image data to a storage location for subsequent use in tracking the mailpiece;
means for calculating postage data as a function of the representative data;
means for printing an indicia on the mailpiece that represents the postage data;
means for generating a control signal as a function of the representative data; and
means for modifying operation of a mailing machine as a function of the control signal.

14. Cancelled.

15. The apparatus as claimed in claim 13, wherein the means for calculating postage data further comprises:
means for adding a surcharge to a postage amount for the mailpiece to account for additional services specified for the mailpiece in the representative data.

16-19. Cancelled.

20. The apparatus as claimed in claim 13, wherein the means for modifying includes means for temporarily pausing operation of the mailing machine.

21. The apparatus as claimed in claim 13, wherein the representative data includes a barcode.

22. The apparatus as claimed in claim 13, wherein the representative data is encoded.

23. The apparatus as claimed in claim 13, wherein the representative data is encrypted.

24. The apparatus as claimed in claim 13, wherein the representative data uniquely identifies the mailpiece.

25-30. Cancelled.
